(19) United States
(12) Patent Application Publication
(10) Pub. No.: US 2007/0117556 A1
(43) Pub. Date: May 24, 2007

(54) Handset powered wireless table top conferencing system

(76) Inventor: Gary Rogalski, British Columbia (CA)

Correspondence Address: Michael Bednarek;Pillsbury Winthrop Shaw Pittman LLP, 1650 Tysons Boulevard, McLean, VA, 22102-4859, US

(21) Appl. No.: 11/270,639

(22) Filed: Nov. 10, 2005

(51) Int. Cl. H04M 3/42

(52) U.S. Cl. 455/416

(57) ABSTRACT

A system and method for portable table top phone conferencing using a handset. A handset is configured to plug into a table top wireless conferencing device. Preferably, the table top conferencing device preferably includes a cradle that accepts the handset which is used to power the conferencing device. The handset is wirelessly connected to a base station using an RF link. Alternatively, the handset is a wireless telephone. A hardwired communications link between the headset and conferencing device establishes a two-way audio connection between the conferencing device and base station.

### BACKGROUND

1. Field of the Invention

The present invention relates generally to telephone systems. More particularly, the present invention relates to table top conferencing systems.

2. Background

Communications through table top teleconferencing provides a convenient method for a group of persons in a particular location to participate in a phone conversation with a person or persons located elsewhere. An advantage of tabletop teleconferencing in which a group of users sits at a conference table is the ability of persons at the conference table to independently and rapidly communicate with others at the conference table, while conducting a phone conversation with a remote party. Thus, audio and visual information can be shared within the group at the conference table while a conversation with remote parties is maintained.

In order to improve table top teleconferencing, typically a full duplex speakerphone system is employed to allow users from any point in a conference room to hear and converse with remotely located parties. Typically, high quality table top teleconferencing equipment (also termed hereinafter “conference phone” or “conferencing device”) requires a PSTN phone connection and a power source to power the conferencing device. FIG. 1 shows known table top conference phone 100, including keypad 102, microphones 104, and speakers 106. Capabilities of known conference phones such as phone 100 include the ability to receive a natural speaking voice of a user within a range of about 15-20 feet or so of phone 100, using microphones 104 and 108, making it easy for a remote party to hear conversation from speakers widely dispersed within a room containing the conference phone. Additionally, known speakers 106 can be of a high enough quality to transmit clear audible information received from the remote party to users dispersed within a large conference room.

Although known system 100 and other like systems provide a convenient manner in which to carry out a teleconference, nevertheless significant limitations are present that reduce its effectiveness. In addition to the need for a phone line connection, typically such systems require power from an AC outlet for operation of the conference phone. Thus, lengthy cables 101, 103 and connectors (such as an RJ11 connector) associated with wired connections to a PSTN and AC power source are required for proper operation of the conference phone. These requirements serve to limit portability and increase the expense of such conference phones.

Known fully wireless conference phones that obviate the need for an RJ11 type connection to a PSTN line exist. For example, FIG. 2 illustrates basic features of a known wireless conference phone 200. Wireless conference phone 200 includes portable conference “pod” 202 that contains keypad 204, microphones 206, and speakers 208. Pod 202 communicates by RF with base station 210 that can be plugged into a PSTN line. Accordingly, phone 200 increases portability of teleconferencing by allowing a phone conference to be established anywhere within an RF communications range between portable base station 210 and portable pod 202. However, the latter conference phone entails significant additional expenses over traditional conference phones, because of the need to build into the pod a radio 212 and associated hardware (not shown) to transmit and receive wireless signals.

Accordingly, it will be appreciated that a need exists to improve conference phone capabilities.

### SUMMARY

In one embodiment of the present invention, a system for portable tabletop teleconferencing includes a handset that is configured to communicate over a telecommunications network and to supply power to an external device. Preferably the handset is coupled to a base station through an RF communications link. The system further includes a table top conferencing device configured to receive power from the handset to facilitate communications over the telecommunications network. The tabletop conferencing device receives power from the handset when the handset is coupled to the conferencing device and a discharge mode is active. In one embodiment, an audio link to the conferencing device is established using a wire from a headset jack of the handset to a receptacle in the conferencing device. Accordingly, a portable teleconference can be established in any location in the vicinity of a cordless telephone, and in conjunction with any cordless system capable of sending power from a portable handset.

In another embodiment of the present invention, a handset-powered table top conferencing device contains one or more speakers. The device also contains a speaker driver for controlling the speakers and one or more microphones for receiving voice input. A digital signal processor for audible sound management is also included in the device. The device further includes an interface for coupling with a handset that is configured to supply power to the conferencing device and a keypad for audio management during a teleconference. Accordingly, a teleconference can be conducted with the conferencing device untethered by wires to telephone line connections or power connections.

In another embodiment of the present invention, a handset for table top phone conferencing includes an RF communications link to a telecommunications network. In one embodiment, the communications link is a link to a base station of a cordless phone system. The handset further includes a battery for powering the handset and a set of contacts for coupling to a table top conferencing device. The handset also includes a circuit for permitting flow of power from the battery to the tabletop conferencing device. When the circuit is engaged and the handset is coupled to the table top conferencing device, the conferencing device is powered by the handset.

In another embodiment of the present invention, a method for conducting a telephone teleconference includes a step of arranging a conferencing device within a wireless communications range of a base station. In one embodiment, the base station is a base station of a cordless phone system. A handset is coupled with the conferencing device. An RF link is established between the handset and base station. A teleconference is initiated using the conferencing device, whereby the conferencing device is powered by the handset.

### DESCRIPTION OF THE DRAWINGS

FIG. 1 illustrates a known table top conference phone.

FIG. 2 depicts basic features of a known wireless conference phone.

FIG. 3 depicts a system for portable tabletop teleconferencing, according to an exemplary embodiment of the present invention.

FIG. 4 illustrates details of a conference pod, according to an embodiment of the present invention.

FIG. 5 depicts exemplary features of handset, according to another embodiment of the present invention.

FIG. 6 illustrates handset, according to a further embodiment of the present invention

FIG. 7 illustrates exemplary steps involved in a method for conducting a teleconference using a portable teleconference device, according to an embodiment of the present invention.

FIG. 8 illustrates further exemplary steps involved in a method for operating a teleconference using a portable teleconference device, according to an embodiment of the present invention.

FIG. 8a illustrates further details of an exemplary step of FIG. 8.

FIG. 9 illustrates exemplary steps for automatic conferencing operation in low power mode, according to an exemplary embodiment of the present invention.

FIG. 10 illustrates exemplary steps for automatic conferencing operation in high quality mode, according to an exemplary embodiment of the present invention.

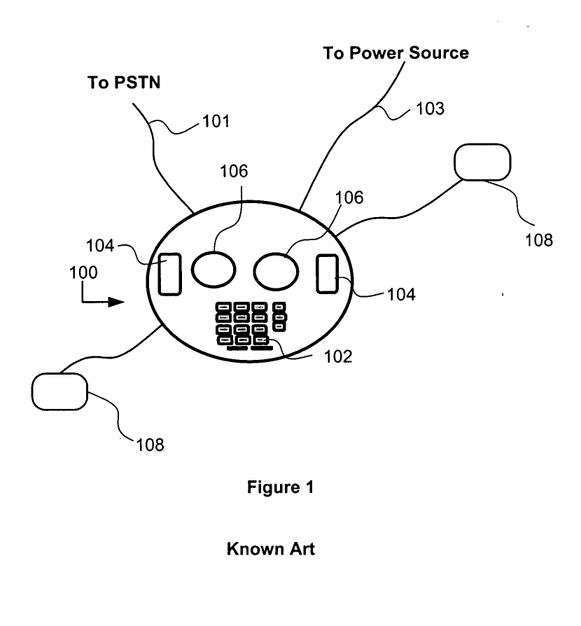

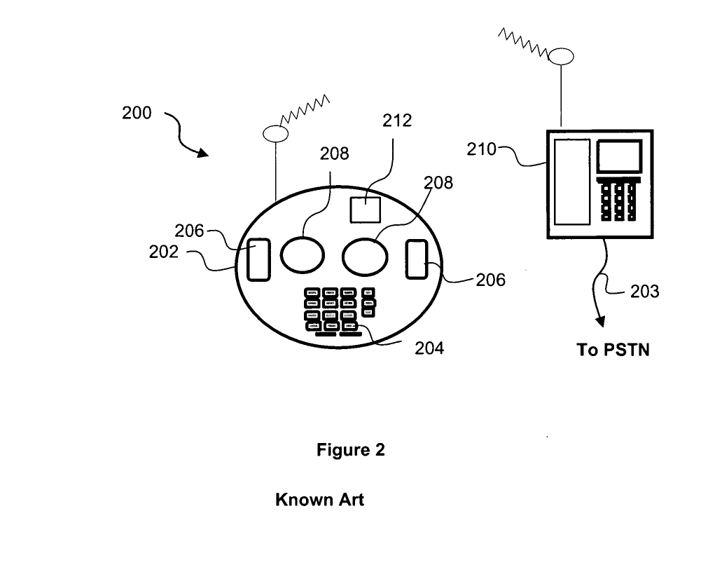

### DETAILED DESCRIPTION OF THE INVENTION

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

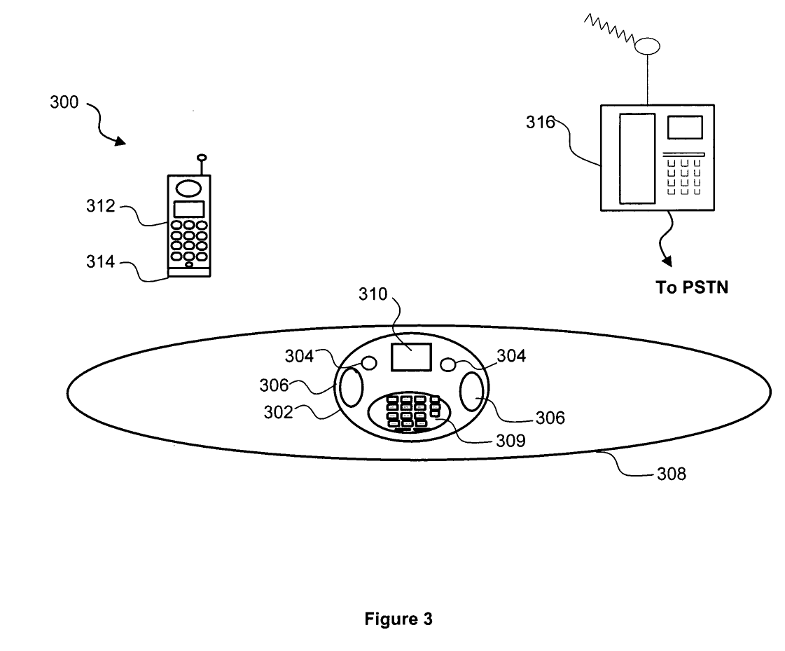

FIG. 3 illustrates a handset-powered teleconferencing system 300, according to an embodiment of the present invention. System 300 includes table top conferencing device (also hereinafter termed “pod” or “conference pod”) 302 that is used to facilitate a teleconference for users in close proximity to table 308. Pod 302 includes microphones 304 and speakers 306 to receive and transmit, respectively, audio input from users in proximity to table 308. Table 308 is, for example, a table in a conference room. In another example, table 308 is a desk in a user's office. Alternatively, table 308 can be any surface capable of supporting pod 302. Thus, use of pod 302 facilitates conducting a teleconference in a variety of settings.

Pod 302 also includes keypad 309 that is used, for example, for dialing telephone numbers and audio management of a teleconference. Audio management includes manually controlling speaker output and microphone input. For example, speaker volume and microphone muting can be controlled through keypad 309.

Pod 302 further includes interface 310. In an exemplary embodiment of the invention, interface 310 is a cradle that is configured to accept handset 312. Handset cradle 310 preferably contains contacts (not shown) that electrically engage contacts (not shown) of handset 312 when the latter is placed in cradle 310. Handset 312 contains battery 314 used to power handset 312 during operation. In an exemplary embodiment of the present invention, handset 312 is used to supply power to pod 302 when placed in cradle 310. Accordingly, a teleconference using pod 302 can be conducted where operation power of pod 302 is received solely from handset 312.

System 300 is configured to allow a phone call to be placed or received by handset 312 when it is coupled to interface 310. An RF link between handset 312 and base station 316 is established during the phone call. For example, handset 312 and base station 316 can communicate using a Worldwide Digital Cordless Telecommunications (WDCT) protocol. In an exemplary embodiment, base station 316 is configured to connect to a conventional PSTN line. When a phone call is initiated to or from handset 312 while it is coupled with interface 310, speakers 306 and microphones 304 are activated by power supplied from battery 314. Thus, from a teleconference user's point of view, pod 302 acts to amplify and improve the quality of sound transmitted from a receiver of handset 312. From a point of view of a remote party, system 300 acts to amplify and improve the audio input into handset 312, such that voice input from many users within a room can be clearly received and understood by the remote party.

An advantage of system 300 over conventional handsets having speakerphone capability is that the quality of sound received and transmitted is far superior, since audio signals are sent and received through pod 302 rather than directly through handset 314.

Another advantage of system 300 over known wireless speaker phones is that an expensive radio need not be built into the conference pod. A further advantage is that no batteries requiring frequent recharging and replacing are needed for the conference pod.

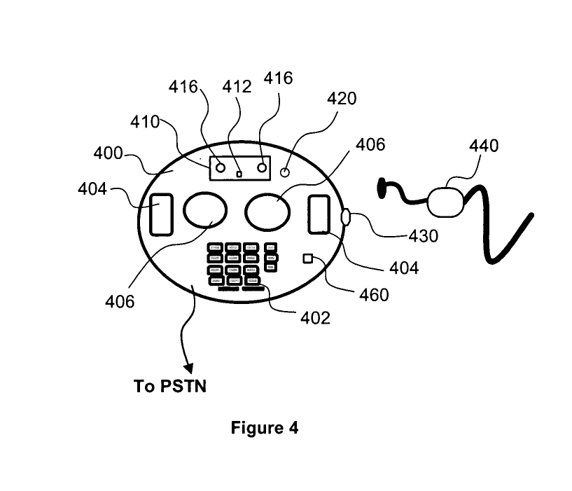

FIG. 4 illustrates details of a conference pod 400, according to an embodiment of the present invention. Pod 400 includes microphones 404 and speakers 406, as well as keypad 402. Preferably, keypad 402 includes keys for increasing and decreasing speaker volume, and microphone muting. Cradle 410, which is an exemplary form of interface 310, includes contacts 416 that electrically engage contacts of a handset placed therein, for example handset 312, so that battery current from the handset can supply power for operation of pod 400. Pod 400 also contains a signal connector 420, preferably a signal jack, that is used to communicate signals to and from the handset via its headset jack when the handset is placed in cradle 410. For example, a known headset wire can be used to plug into signal jack 420 and a conventional headset jack in the handset that is inserted in cradle 410. Cradle 410 also includes signal connector 412 that is designed to couple to a signal jack located on a handset base region specially adapted to fit into cradle 410. Thus, when a specially adapted handset is inserted into cradle 410, an electrical connection to transmit audio signals as well as data such as call control signals between the handset and pod 400 is automatically established. Preferably, signal connector 412 is configured so that a handset without a signal jack in a base region of the handset can electrically couple to contacts 416 without interference from signal connector 412. Thus, cradle 410 is configured to accept handsets with and without special signal jacks located in the base region.

In one embodiment, cradle 410 is configured to accept a handset of standard base region dimensions. In another embodiment, cradle 410 is designed to couple to handset of specially designed dimensions. In still another embodiment, cradle 410 is configured to accept a flexible insert (not shown) designed to allow handsets of varying base dimensions to fit snugly within cradle 410.

It is noted that cradle 410 can be configured to receive a wireless telephone (cell phone) or other wireless communications device or handset that is capable of carrying voice signals. Thus, in another embodiment of the invention, system 400 provides a means for conducting a teleconference using power from a wireless telephone.

Preferably, pod 400 includes a digital signal processor and speaker drivers to implement full duplex speakerphone functionality including echo cancellation and background noise reduction.

Pod 400 also contains connector 430 to couple to optional AC adapter 440 that is configured to connect to an AC power source for use, for example, when battery power of a handset is low, or to replenish power to the battery handset when convenient.

Also located in pod 400 is power source detector 460 that detects if power is being received from an AC power supply or DC battery.

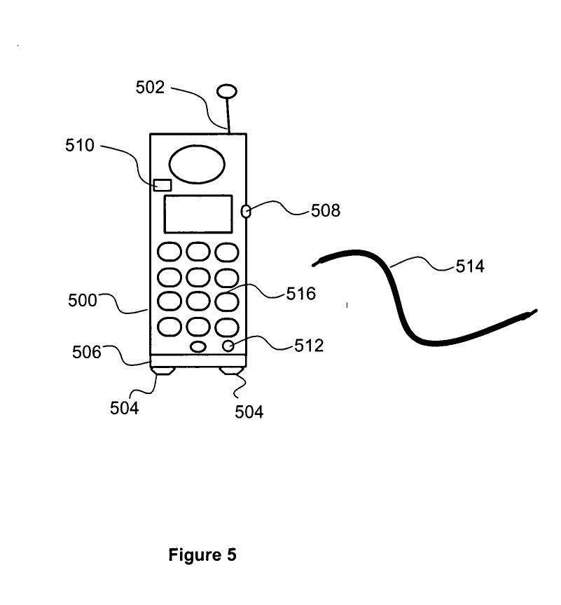

FIG. 5 depicts exemplary features of handset 500, according to another embodiment of the present invention. In one embodiment of the invention, handset 500 includes antenna 502 that can be used to establish an RF link to a base station, for example, base station 316 of FIG. 3. Handset 500 is configured to receive and send phone calls in a known manner. For example, referring also to FIG. 3, when a caller dials a number associated with handset 500, base station 316 establishes an RF duplex link with handset 500 and a user can answer the call at the handset. In another embodiment of the invention, handset 500 is a wireless phone that can receive a phone call directly over a wireless network without the use of a base station linked to a land line connection.

Handset 500 is also configured to engage a cradle of a conference pod, for example, pod 400 of FIG. 4. Referring now also to FIG. 4, handset contacts 504 engage cradle contacts 416 when handset 500 is placed therein. Using battery 506, handset 500 can subsequently supply power to operate pod 400. Circuit 510 is included in handset 500 to connect battery 506 to pod 400 and allow battery power to flow from battery 506 to pod 400. For example, when a user places handset 500 in pod 400, if an electrical path exists from battery 506 to contacts 504, power can flow from battery 506 to an external device connected to the contacts, such as pod 400. Circuit 510 acts to establish current flow between battery 506 and contacts 504. In one embodiment, circuit 510 provides separate rectifying electrical current paths that allow current to flow either exclusively in the direction from battery 506 to contacts 504 or in the direction from contacts 504 to battery 506. By switching the rectifying electrical current path used to connect battery 506 and contacts 504, the flow of current between handset 500 and an external device can be regulated. In other words handset operation can be switched from a charge mode, where battery 506 accepts external power, to a discharge mode, where battery 506 supplies power both to handset 500 and to an external source. In one embodiment, detection circuit 512 is provided to detect the presence of an external power source connected to pod 400. If no power source is detected, then circuit 510 can be automatically set in a discharge mode configuration, such that battery 506 acts as a power supply for electrical components in handset 500 and pod 400. If an external source of power to pod 400 is detected, detection circuit 512 can send a signal to switch circuit 510 so that battery 506 can receive power from pod 400. Preferably, handset 500 also includes protection circuits that, when engaged, prevent battery 506 from discharging power to any other devices besides pod 400, and allow battery 506 to be charged when placed in a separate charging cradle (not shown) or a cradle in a base station. Thus, handset 500 can be changed from a charge to a discharge mode when needed to power a conference pod, as well as be isolated from other external devices.

Handset 500 also contains headset jack 508 that is used to couple to jack 420 in pod 400, as described above. A communications link can be established from base station 316 to pod 400 when handset 500 is placed in pod 400 and headset jack 508 is connected to jack 420, for example, using wire 514. A teleconference user or group of users receiving a phone call with handset 500 inserted in cradle 410 can press an “ON” button (not shown) on handset 500 and a duplex audio link is established. Subsequently, the users can employ pod 400 in a conventional manner to conduct a teleconference with the calling party or parties. Alternatively, a user can initiate a teleconference by placing a call using keypad 516 of handset 500 while it is inserted in cradle 404.

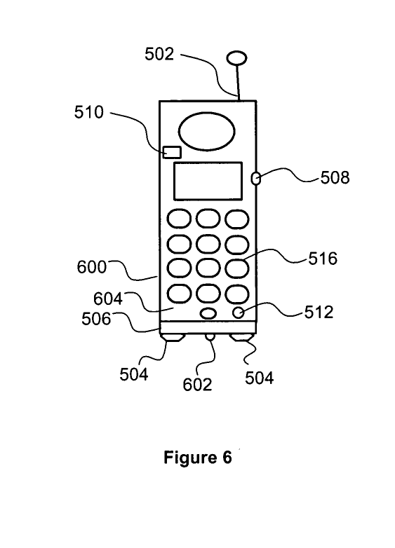

FIG. 6 illustrates handset 600, according to a further embodiment of the present invention. In this embodiment, handset 600 includes a signal jack 602 located in base region 604 that is configured to engage a signal plug of a cradle, for example plug 412 of FIG. 4. Accordingly, an audio signal link and optional data signal link is established between handset 600 and pod 400 when the handset is in cradle 410. The audio signal link can be either an analog or digital link, the latter of which can carry both audio data and control data over the same signal path.

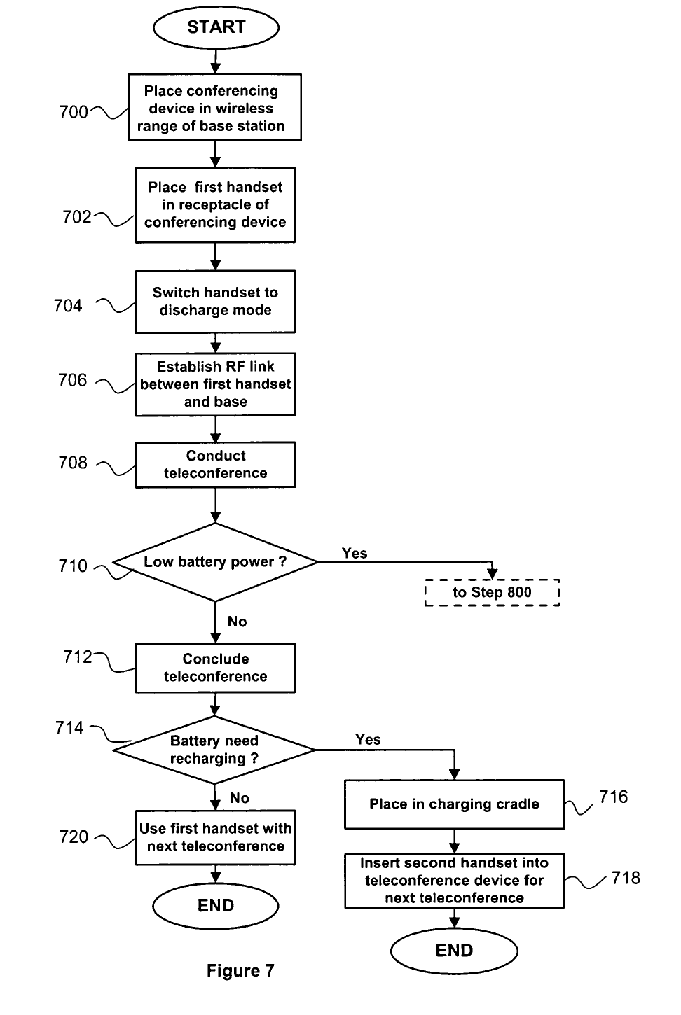

FIG. 7 illustrates exemplary steps involved in a method for conducting a teleconference using a portable conferencing device, according to an embodiment of the present invention. In step 700, the conferencing device is placed within a wireless communications range of a first base station. In a preferred embodiment, the first base station is a base station of a cordless telephone system. Preferably the base station is configured to communicate with one or more handsets over an RF link. Referring also to FIG. 3, for example, pod 302 is set up to be within a wireless communications range of base station 316. In one example, base station 316 and pod 302 are in a same room. Alternatively, base station 316 can be located in a room or other location different than that of pod 302, as long as RF communications can be maintained between them. It is known that RF ranges at frequencies commonly employed for cordless phones, such as 900 MHz, 2.4 GHz, and 5.8 GHz, a communications range between a handset and base station can typically extend to 20 meters or more within buildings, and to several hundred meters or more in outdoor spaces. Thus, for example, teleconference users can place portable device 302 in one office of a building, while base station 316 is located in an office down the hall. Alternatively, a teleconference could be conducted using device 302 in a park located near a building containing a base station linked to a portable handset, such as base station 316. In other words, any place a handset can be used is suitable for placement of pod 302.

In another exemplary embodiment the first base station is a base transmission station (cell tower) of a wireless communications network. In this embodiment, any place that a wireless (cell) telephone can be used is suitable for placement of the pod.

In step 702, a first handset is placed in a receptacle of the conferencing device.

The first handset is configured to establish an RF link with the base station configured in step 700. Thus, for example, handset 312 and base station 316 “belong” to the same telephone device. The receptacle is configured to provide an electrical power connection between handset and conferencing device as described above. In addition, an audio signal connection between the first handset and conferencing device is established, as detailed above.

In step 704, the handset is switched to a discharge mode, in which a battery in the handset discharges power to the conferencing device. Preferably, the switching to discharge mode takes place automatically, for example, after the handset detects that no other external power supply exists to power the conferencing device, as described above with respect to FIG. 5.

In step 706, an RF link is initiated between the first handset and first base station. For example, handset 312 is switched on and a phone number for a called party is dialed. An RF link between handset 312 and base station 316 is established, and a call is placed to the called party.

In step 708, a teleconference using the handset powered teleconferencing device is conducted.

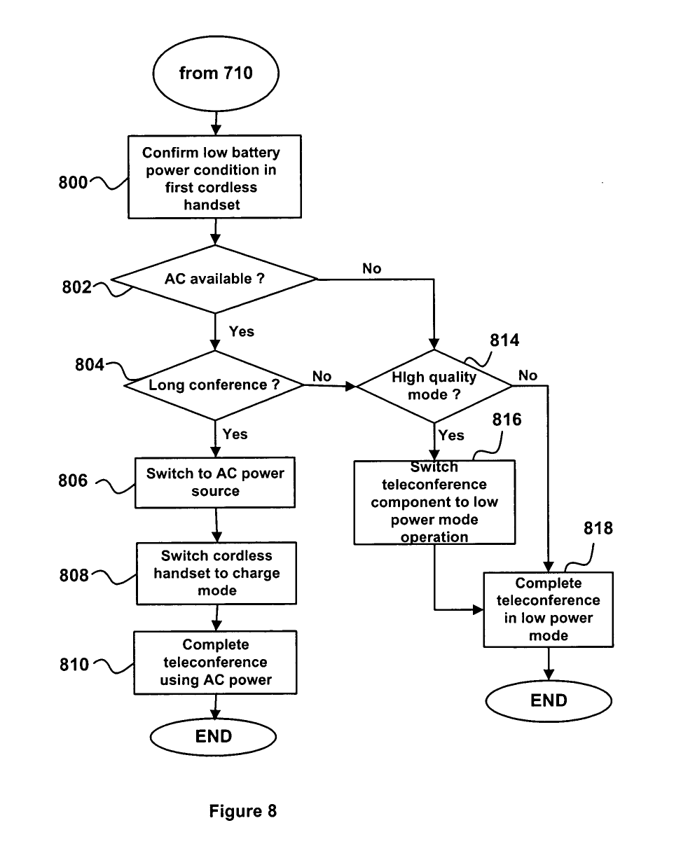

In step 710, a battery power level on the handset is checked. If the power is deemed acceptable according to some predetermined criterion, the process continues to step 712. If a low battery power condition is detected, the process moves to step 800 of FIG. 8.

In step 712, the teleconference is concluded. The first handset can then be powered off and removed from the conferencing device receptacle.

In step 714, if a user detects that battery power is sufficient, and does not require recharging, then the process moves to step 720, where the first handset is used for a next teleconference.

If a battery in the handset is deemed to be in the need of recharging, then in step 716, the handset is placed in a charging cradle to recharge the battery.

In step 718, a second handset is placed in the conferencing device and then used to conduct a subsequent teleconference. In one embodiment, the second handset is a handset belonging to the same base station as the first handset. In another embodiment, the second handset is associated with a second base station, and is configured similarly to the first handset such that battery power and audio signals can be conveniently communicated between the second handset and conferencing device.

Thus, according to the above exemplary steps, combinations of multiple handsets within a given cordless phone system, or handsets belonging to separate cordless phone systems can be used to power a wireless conferencing device. The wireless conferencing device can be moved to any location in wireless communications range or a base station of a cordless phone, and can accordingly be used to communicate over different phone lines and phone numbers.

FIG. 8 illustrates further exemplary steps involved in a method for operating a teleconference using a portable conferencing device, according to an embodiment of the present invention. Continuing from step 710, in step 800, a low battery power condition is confirmed to exist in the first handset. For example, the first handset contains a warning LED that lights to signal low battery power.

In step 802, the availability of an AC power source to power the conferencing device is determined. If an AC power source is available, the process moves to step 804.

In step 804, a determination is made as to how much longer the teleconference will last. If the teleconference may last for a significant time, then the process moves to step 806.

In step 806, an AC power source is engaged to power the conferencing device. For example, adapter 440 in FIG. 4 is plugged into plug 430 of pod 400 and also to an external AC power source.

In step 808, the handset is switched to a charge mode, so that the handset can be recharged. Referring also to FIG. 5, for example, if handset 500 is placed in cradle 410 of pod 400 during a teleconference, circuit 512 can automatically detect the presence of the AC power source, so that circuit 510 switches handset battery 506 to a charge state, wherein current from AC adapter 440 can flow into battery 506.

In step 810, the teleconference is completed with the conferencing device powered by an AC power source. A battery within the first handset is recharged at the same time.

If, in step 802 it is determined that no AC power source is available, or if in step 804 a user determines that a duration of the remaining teleconference is likely to be short, the process moves to step 814.

In step 814, it is determined whether the teleconferencing system components, such as portable handset and conference pod are operating in a high quality mode. If the conferencing components are not operating in a high quality mode, the process moves to step 818 where the teleconference continues. If the device is operating in a high quality mode, the process moves to step 816.

In step 816, the mode of operation of the conferencing system components are switched from the high quality mode to a low power mode.

The process moves to step 818 where the conferencing system components are maintained in a low power operation mode. In low power mode, an acceptable audio quality is maintained in the conferencing pod and handset, as described further with respect to FIG. 8a, but the rate of power consumption of a battery of the first handset is significantly reduced, allowing the teleconference and/or subsequent teleconferences to continue for a significantly longer duration, as compared to operation in high quality mode, before battery power becomes too low to properly operate the conferencing device.

FIG. 8a illustrates further details of step 814, according to one embodiment of the present invention. In step 814a, a determination is made as to whether the handset used to power the conferencing pod is operating in a high quality mode. As regards handset operation, a high quality mode can include such features as multiple time slot use in a time division multiple access (TDMA) device. By employing more than one time slot for a base station to transmit to a handset and for a handset to transmit to a base station during each communications time frame, a link between the handset and a base station provides a higher audio quality. This is due to the lower probability of degrading transmission of audio packets while transmitting the packets between the handset and base, since each packet can be sent over multiple time slots to avoid a time period when interference is greater. However, this high quality operation consumes significantly more power than when a link between handset and base or base and handset is established over a single time slot in a communications frame. Accordingly, the handset battery power depletes at a faster rate.

If the handset is determined to be operating in high quality mode, the process moves to step 816, where low power mode operation for the handset is initiated, including, for example, setting a frame structure such that communication from a base station to a handset takes place over a single time slot in a given communications frame. In one embodiment, the low power mode comprises operation of a single time slot per communications frame for both transmitting from a handset to a base station and transmitting from a base station to a handset. However, in other embodiments, a low power mode may employ multiple time slots for communication in one direction between the base and handset, and only a single time slot for communication in the other direction. In either case, the power used is significantly lower than in high quality mode operation. If the handset is operating in low power mode (the equivalent of not operating in high quality mode), the process moves to step 814b. In one embodiment of the invention, handset operation is automatically switched from high quality to low power mode, when the handset detects that the power level of the handset battery is reduced to a threshold value.

In step 814b, it is determined whether the conferencing pod is operating in a high quality mode. If the pod is not operating in high quality mode, then the process moves to step 818. If the pod is operating in high quality mode, the process moves to step 816, where operation of the pod is switched to low power mode. In the context of operation of a conference pod, high quality mode can entail the ability to operate at a high audio output level from the pod with no volume limit.

In other embodiments of the invention in which a handset battery acts as power source for a teleconferencing pod, either the handset or conference pod, but not both, are switched from high quality to low power operation, even though both teleconference components are detected to be operating in a high quality mode. For example, a handset used to power a conference pod may not have a low power operation mode available, or automatically enabled. Nevertheless, switching the conference pod to low power operation when a low battery condition is detected can act to substantially preserve battery life of the handset for the duration of a call.

In a further exemplary embodiment of the invention, a conference pod automatically receives a signal indicating a low battery condition in a handset battery so that it can automatically switch from high quality operation mode to low power mode when battery power is low. This low battery signal could be sent, for example, over a data link established when the handset is placed in a conference pod cradle.

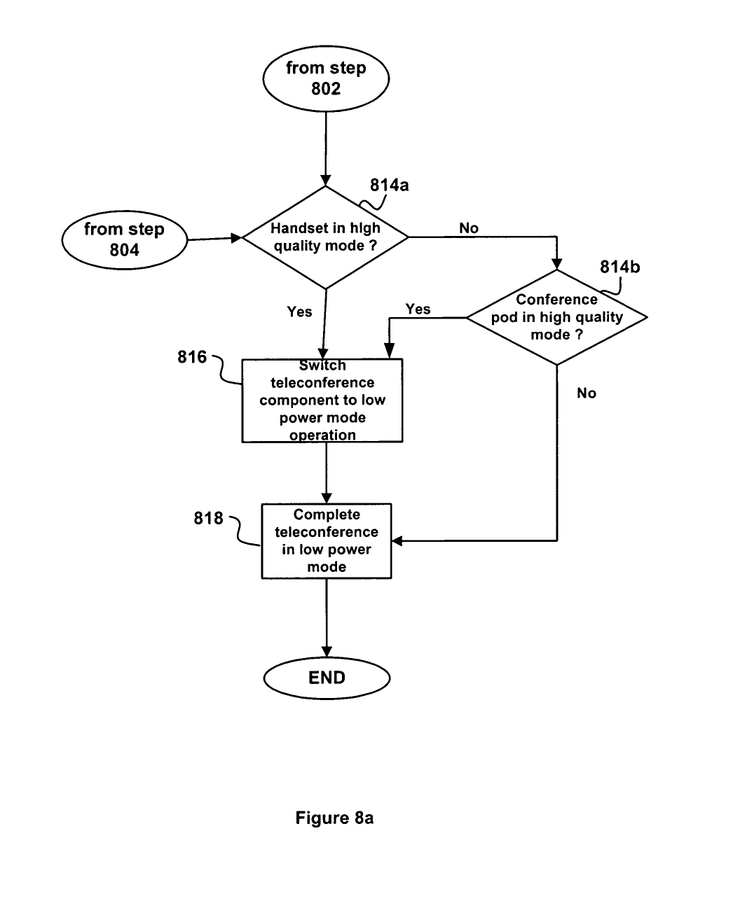

In an alternative embodiment of the present invention, depicted in exemplary steps of FIG. 9, operation in low power mode is automatically commenced when the power source of the portable tabletop teleconference device is a handset battery. In step 900, a handset is inserted in a cradle of a conferencing device. For example, referring also to FIGS. 4 and 5, handset 500 is placed in pod 400.

In step 902, the tabletop device detects that the power source for the device is a battery. For example, pod 400 using detector 416 determines that battery 506 is powering the pod.

In step 904, the tabletop device determines whether it is set to operate in low power mode. If so, the process moves to step 906 where operation of the conferencing device continues in low power mode. For example, pod 400, is configured to automatically initiate a low power mode operation when it detects a battery power source only.

If low power operation is not set, the process moves to step 908 where the tabletop device is switched to low power operation. Thus, in this embodiment, a tabletop conferencing device can automatically adjust its operation mode base on whether it is being powered by an external AC power supply or by a handset battery.

In the exemplary embodiment illustrated in steps 900-908, a handset may not automatically switch to a low power operation if the handset battery power is high. Thus, in one instance, high quality mode operation of the handset may continue in step 906 until a low battery condition is detected and the handset automatically switches into low power mode as described for step 814. Otherwise, if the handset were to automatically switch to low power mode itself when powering a tabletop device, a user would be precluded from operating the handset in a high quality mode that might be desirable to improve communications with a base station. However, it is envisioned that in some embodiments, a low power button can be provided on a portable handset to allow battery power to be preserved even when the battery initially is at full charge, so that a tabletop conference call duration can be maximized when the handset acts as the sole source of power.

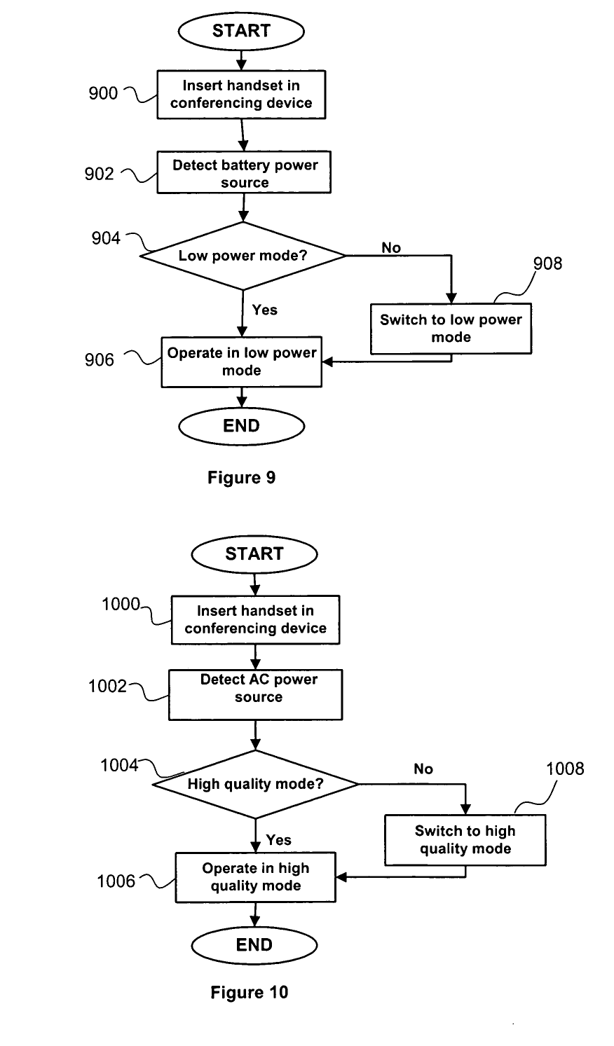

In another embodiment of the present invention, depicted in exemplary steps of FIG. 10, operation in high quality mode is automatically commenced when the power source of the portable teleconference device is an AC power source. In step 1000, a handset is inserted in a cradle of a teleconferencing device. For example, referring also to FIGS. 4 and 5, handset 500 is placed in pod 400.

In step 1002, the conferencing device detects that the power source for the device is an AC supply. For example, pod 400 using detector 416 determines that AC adapter 414 is powering the pod.

In step 1004, the conferencing device determines whether it is set to operate in high quality mode. If so, the process moves to step 1006 where operation of the conferencing device continues in high quality mode. For example, pod 400, is configured to automatically initiate a high quality mode operation when it detects an AC source.

If high quality operation is not set, the process moves to step 1008 where the conferencing device is switched to high quality operation.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For example, although embodiments of the invention discussed above employ handsets of cordless phone systems to power a conferencing device, embodiments in which cell phones or other similar devices are used in lieu of a handset have been contemplated by the inventor. In addition, although the aforementioned embodiments focused on arrangements in which a handset is in wireless communication with a base station, embodiments in which a conference pod is directly connected to a PSTN line are considered to be within the scope of the invention. In other words, embodiments of the invention can include a dual mode operation in which a handset can be used to either power a conference pod for a wireless communication from the handset to a base station, or power a wired communication from the pod to an external PSTN (see FIG. 4). The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. In particular, in addition to those steps disclosed in FIGS. 7-10, many combinations of manual and automatic steps are possible for altering the mode of operation of the conferencing device. For example, during a teleconference, a user can remove a first handset from a conference pod when its battery is low and replace it with a second handset belonging to the same base station as the first handset. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for portable tabletop teleconferencing, comprising:
a handset configured to communicate over a telecommunications network and to supply power to an external device; and
a table top conferencing device configured to receive power from the handset to facilitate communications over the telecommunications network.

2. The system of claim 1, wherein the table top conferencing device comprises:
an interface configured for coupling with the handset and configured to electrically couple to the handset to receive power therefrom;
one or more speakers;
a speaker driver for controlling the speakers; and
one or more microphones for receiving voice input.

3. The system of claim 2, further comprising:
a digital signal processor for audible sound management.

4. The system of claim 2, wherein the interface further comprises a signal connector for receiving from the handset into the table top conferencing device one of an audio input signal, a data control signal, and both an audio input signal and data control signal.

5. The system of claim 2, wherein the interface comprises a cradle configured to hold the handset.

6. The system of claim 1, further comprising a base station in communication with the communications network and coupled to the handset through a wireless communications link.

7. The system of claim 5, wherein the signal connector is located within the cradle and is configured to engage a headset jack of the handset place therein.

8. The system of claim 1, wherein the handset comprises:
a battery for supplying power to the table top conferencing device;
a circuit for permitting flow of power from the battery to a device external to the handset; and
a discharge mode for controlling power in the battery, wherein power is discharged from the battery to the table top conferencing device when the discharge mode is initiated.

9. The system of claim 8, further comprising an AC power adapter configured to supply power from an AC power source to the table top conferencing device.

10. The system of claim 9, wherein the handset is configured to accept a battery charge when the AC power adapter is engaged while the handset is in the cradle.

11. The system of claim 9, further comprising a power source detector-that detects whether the conference device is powered by the AC power source or by the battery.

12. The system of claim 10, wherein the table top conferencing device further comprises:
a low power operation mode associated with a first audio quality; and
a high quality operation mode associated with a second audio quality that is superior to the first audio quality.

13. The system of claim 12, wherein the high quality operation mode comprises a higher maximum level of audio output volume than for operation in a low power mode

14. The system of claim 1, further comprising a PSTN connection to the table top conferencing device, wherein the handset can be used to power the table top conferencing device during a wireless communication from the handset to a base station, or during a wired communication from the table top conferencing device to an external PSTN.

15. The system of claim 12, wherein the table top conferencing device is configured to automatically operate in the low power mode when the conference device detects that it is being powered by the battery alone.

16. The system of claim 3, wherein the digital signal processor directs the functions of echo cancellation and noise reduction.

17. The system of claim 2, wherein the table top conferencing device further comprises a keypad for audio management when the handset is engaged in the handset cradle.

18. The system of claim 1, wherein the handset comprises a wireless device in direct communication with a wireless telecommunications network.

19. A handset-powered table top conferencing device, comprising:
one or more speakers;
a speaker driver for controlling the speakers;
one or more microphones for receiving voice input;
a digital signal processor for audible sound management;
an interface for coupling with a handset that is configured to supply power to the conferencing device; and
a keypad for audio management during a teleconference.

20. The device of claim 19, wherein the interface comprises a cradle configured to hold the handset.

21. The device of claim 19, the interface further comprising a signal connector for receiving an input signal from the handset into the table top conferencing device, the input signal comprising one of an audio input signal, a data control signal, and both an audio input signal and data control signal.

22. The device of claim 19, further comprising an AC power receptacle configured to receive power from an AC power source.

23. The device of claim 22, further comprising a power source detector that detects whether the conference device is powered by the AC power source or by the handset.

24. The device of claim 19, further including:
a low power speaker phone mode for associated with a first audio quality; and
a high quality speaker phone mode associated with a second audio quality that is superior to the first audio quality.

25. The device of claim 18, wherein the handset is coupled over a wireless link to a base station that is in communication with a telecommunications network.

26. The device of claim 18, wherein the handset comprises a wireless device in direct communication with a wireless telecommunications network.

27. A handset for table top telephone conferencing, comprising:
an RF communications link to a telecommunications network;
a battery for powering the handset;
a set of contacts for coupling to a table top conferencing device; and
a circuit for regulating flow of power between the battery and the tabletop conferencing device.

28. The handset of claim 27, further comprising a discharge mode, wherein the handset is configured to discharge power from the battery to the table top conferencing device when the discharge mode is initiated.

29. The handset of claim 27, further comprising a signal jack for sending and receiving an input signal from the table top conferencing device, the input signal comprising one of an audio input signal, a data control signal, and both an audio input signal and data control signal.

30. The handset of claim 29, wherein the signal jack is configured to engage an interface in a cradle of the table top conferencing device.

31. The handset of claim 27, wherein the RF communications link comprises a link to a base station of a cordless telephone system.

32. The handset of claim 27, wherein the RF communications link comprises a direct link to a wireless telecommunications network.

33. The handset of claim 27, further comprising a low power mode, wherein handset operation in the low power mode is automatically initiated when a battery power of the handset is low and the handset is not connected to an external power source.

34. The handset of claim 27, wherein the low power mode comprises use of a single time slot for communication from the handset and a base station and a single time slot for communication from the base station to the handset during a communications frame.

35. A method for conducting a telephone teleconference, comprising:
arranging a conferencing device within a wireless communications range of a base station;
coupling a handset with the conferencing device;
establishing an RF link between the handset and base station; and
initiating a teleconference using the conferencing device, whereby the conferencing device is powered by the handset.

36. The method of claim 35, further comprising switching the handset to a discharge mode.

37. The method of claim 35, wherein the base station comprises a base station of a cordless telephone system and the handset is a handset of the cordless telephone systems.

38. The method of claim 35, wherein the base station comprises a base transmission station of a wireless telecommunications network and the handset is a wireless phone.

39. The method of claim 36, wherein power is discharged from a battery located in the handset to the conferencing device when the discharge mode is active.

40. The method of claim 35, further comprising:
detecting a low power condition in the battery of the handset; and
if the teleconferencing device is operating in a high quality operation mode, switching to operation in a low power mode.

41. The method of claim 35, further comprising:
detecting that the conferencing device is powered solely by the battery of the handset; and
if any of the teleconferencing device and the handset is operating in a high quality operation mode, switching at least one of the teleconferencing device and the handset to operation in a low power mode.

42. The method of claim 39, further comprising:
detecting an AC power source supplying power to the conferencing device; and
switching to a charge mode wherein the battery of the handset is charged by the AC power source.

43. The method of claim 42, further comprising switching to a high quality operation mode if the conferencing device is operating in low power mode.

44. The method of claim 39, wherein the RF link comprises a duplex link of a digital communications system.
